(19) United States
(12) Patent Application Publication
(10) Pub. No.: US 2022/0099585 A1
(43) Pub. Date: Mar. 31, 2022

(54) METHOD FOR CAPTURING A COATING OF A COMPONENT, IN PARTICULAR OF A MACHINE, THE COATING BEING FORMED FROM A FIRST MATERIAL

(71) Applicant: Siemens Energy Global GmbH & Co. KG, Munich, Bayern (DE)

(72) Inventors: Stefan Denneler, Munchen (DE); Jens Dahl Jensen, Berlin (DE); Oliver Stier, Berlin (DE)

(73) Assignee: Siemens Energy Global GmbH & Co. KG, Munich, Bayern (DE)

(21) Appl. No.: 17/425,363

(22) PCT Filed: Jan. 17, 2020
(86) PCT No.: PCT/EP2020/051165

§ 371 Date: Jul. 23, 2021

(30) Foreign Application Priority Data
Jan. 30, 2019 (DE) 10 2019 201 164.0

(51) Int. Cl. G01N 21/84; C23C 28/02; F01D 5/28; G01N 21/88

(52) U.S. Cl. CPC G01N 21/8422; C23C 28/022; F01D 5/288; G01N 21/8803; G01N 21/9515; F05D 2230/90; F05D 2260/81; G01N 2021/8433; G01N 2021/888; G01N 21/8851

(57) ABSTRACT

A method for capturing a coating of a component, which component has at least one first subregion and at least one second subregion, which adjoins the first subregion and in which the main body is free of the coating, wherein: first electromagnetic radiation reflected by the first subregion of the component and second electromagnetic radiation reflected by the second subregion of the component are sensed by a detection device; first data, which characterize the first electromagnetic radiation, and second data, which characterize the second electromagnetic radiation, are produced; a virtual, three-dimensional model of the component is produced in dependence on the data.

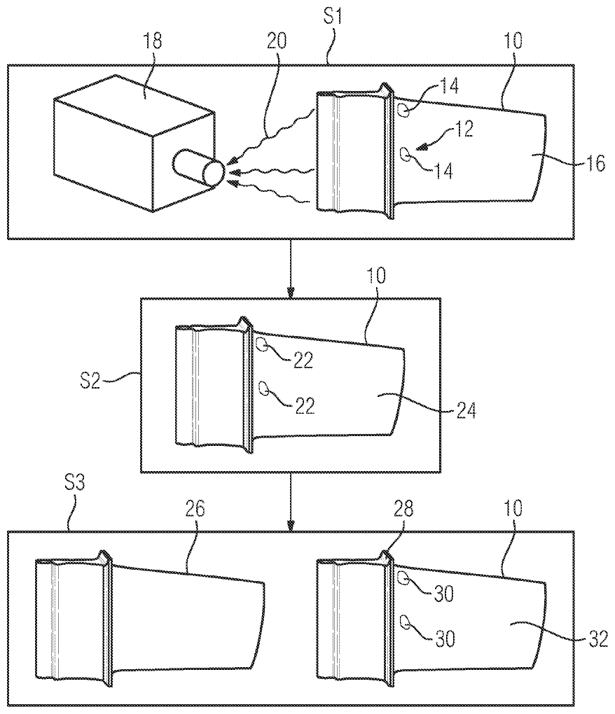

### CROSS REFERENCE TO RELATED APPLICATIONS

This application is the US National Stage of International Application No. PCT/EP2020/051165 filed 17 Jan. 2020, and claims the benefit thereof. The International Application claims the benefit of German Application No. DE 10 2019 201 164.0 filed 30 Jan. 2019. All of the applications are incorporated by reference herein in their entirety.

### FIELD OF INVENTION

The invention relates to a method for capturing, in particular for visualizing, a coating, formed from a first material, of a component, in particular of a machine, for example of a fluid energy machine.

### BACKGROUND OF INVENTION

In machines, for example fluid energy machines, which may for example be configured as a gas turbine or as an aircraft engine, blades are used. A respective blade is therefore a component of the machine. In order to be able to be used in the liquid energy machine, configured for example as an engine, the respective blade, or the respective blade body can withstand particularly large thermal and mechanical loads.

So that these requirements can be satisfied, the respective blade, in particular for example a gas turbine blade, is correspondingly produced in general from highly complex materials, for example in complex 3D geometries and with elaborate cooling air channels. In this case, the complexity in the structure generally leads to particularly high production costs overall. In order to be able to make the thermal load-bearing capacity of the blade particularly high, the blade is conventionally provided with a plurality of protective layers, which need to be repaired by maintenance measures after a certain amount of loading during use of the fluid energy machine.

For repairing the protective layers of the blade, a plurality of processes, so-called refurbishment processes, are carried out. For example, in an in particular multistage process which consists for example of chemical or electrochemical etching, sandblasting and grinding, in which case the individual process steps may respectively be carried out repeatedly, old layers or layer residues of the protective layers are removed from the blade.

In this case, the problem arises that removal of the residual layers or the layers on the blade or a further component of the machine, which may likewise have refractory cladding, proves difficult even for an experienced technician. Layer residues on the blade can be identified only to a limited or particularly small extent, even by such a technician.

In this case, the layer comprises for example a ceramic and an adhesion promoter that connects the ceramic to the blade, which consists in particular of a metallic material. In this case, in general at least the ceramic part of the residual layer or coating is removed by sandblasting by the technician. The adhesion promoter must generally be removed by etching.

So that the layer residues can then subsequently be identified, it is common practice to carry out a heat treatment after removing the first layers or layer residues. The in particular metallic material of the component, i.e. of the blade, generally comprises cobalt, which becomes blue-colored during a heat treatment, or during heating. At the same time, the layer or the layer residues change color, in particular for example because of the material, contained in the layer, which comprises MCrAlY, where M stands for substantially any metal and the remainder denotes chromium-aluminum-yttrium. This heat treatment is referred to as heat-tint because of the blue coloration of the material of the base body of the component, i.e. of the blade.

By this heat-tint, it is possible to see clearly where there are still residual layers on the blade. This residual layer may therefore be correspondingly removed by the technician during finishing. In this case, although this heat-tint method is a reliable indicator for identifying residual layers during visual inspection, this heat-tint method is however particularly time- and energy-consuming, so that its implementation significantly lengthens the refurbishment processes and at the same time, in particular because of the energy required therefor, entails a particularly large cost factor in the reconditioning of the blade, or of the component. The heat-tint does not give a reliable indication of the thickness of the layer residues, so that the technician is provided with no suggestion of how much they need to remove. They will thus work cautiously in order to preserve the blade base body and thus run the risk of having to repeat the steps of layer removal plus heat-tint. For the technician, it would be extremely advantageous to be able to establish directly whether there are still any layer residues, because they may then immediately end the processing when no more residues are indicated.

### SUMMARY OF INVENTION

The object of the present invention is therefore to provide a method by means of which layers of a first material on a component, the base body of which consists of a second material, can be captured particularly advantageously so that processing of the component can be carried out particularly efficiently.

This object is achieved according to the invention by the subject matter of the independent patent claim. Advantageous configurations and refinements of the invention are specified in the dependent patent claims and in the description and in the drawing.

A method according to the invention is used to capture, for example for subsequent visualization, a coating, formed from a first material, of a component, which is in particular a component of a machine, for example of a fluid energy machine, and which has at least one first subregion in which a base body, formed from a second material different to the first material, of the component is provided with the coating. In this case, the component furthermore comprises at least one second subregion, adjacent to the first subregion, in which the base body is free of the coating, or of the first material.

So that the coating, or the first material of the component, which in particular is part of a machine, in particular as a blade for example for a gas turbine, may be captured particularly advantageously, at least one first electromagnetic radiation having at least one first wavelength and reflected by the first subregion of the component and one second electromagnetic radiation, in particular having at least one second wavelength different to the first wavelength, reflected by the second subregion of the component are captured by means of a detection device. In this case, the detection device may for example be a camera device, which in particular is configured to capture a particularly large part of the electromagnetic spectrum, which in particular extends beyond the part of the electromagnetic spectrum visible to the human eye. In this case, the wavelength range capturable in particular by the detection device may be selected in such a way that within it the reflection property of the first material differs from the reflection property of the second material. To this end, the detection device may for example itself comprise a suitable light source, or source of the electromagnetic radiation, by means of which for example the component may be illuminated by the detection device so that the for example electromagnetic radiation reflected by the illumination is captured.

Furthermore, in the method according to the invention, first data, which characterize the first electromagnetic radiation and therefore the first subregion of the component, and second data, which characterize the second electromagnetic radiation and therefore the second subregion of the component, are generated. If, for example, a recording is generated by the detection device when capturing the reflected electromagnetic radiation of the respective subregion, for the generation of the data this recording is then evaluated with a view to characterization of the at least one first subregion and of the at least one second subregion. For example, a first color may be assigned to the first subregion, which comprises the first material with different reflection properties to the second material, while a second color may be assigned to the second subregion, which is free of the first material. In this case, the data are determined for example by mathematical processing of the in particular digital recording of the detection device, so that the data may for example be available as a false-color image of the recording. Thus, in the simple case, for example with the aid of binary encoding, distinction may clearly be made between the at least one first subregion and the at least one second subregion by assigning a first color to the first subregion and a second color to the second subregion. In this case, for the compilation of the data, a limit value is for example specified if both the first material and the second material may be captured by the detection device in one subregion, so that this subregion may be assigned clearly to one of the first subregions, or to the first subregion, or clearly to at least one of the second subregions, or to the second subregion.

Furthermore, by means of the method according to the invention, a virtual three-dimensional model of the component is generated as a function of the data, so that the virtual model comprises a virtual first region corresponding to the first subregion and a virtual second subregion corresponding to the second subregion. In this case, for example, an already existing three-dimensional model of the component, for example a CAD (computer-aided design) model, is employed, which is used for an inverse projection as a projection surface of the data, which exist for example as a false-color image. Thus, for example, for the generation of the virtual three-dimensional model of the component, which generates the corresponding subregions, by fusion, in particular data fusion, the already existing three-dimensional CAD model is fused with the data.

In other words, the method according to the invention is based in particular, for example, on a combination of an in particular digitized imaging method, in which in particular for example the detection device is involved, with in particular mathematical machine vision by which the data, i.e. the first data and the second data, can be generated with the aid of the results of the imaging method. These data are correlated with the shape or the configuration or the three-dimensional embodiment of the component, or combined therewith, in such a way that it is possible to generate an in particular three-dimensional model of the virtual component on which the places where there are particles or deposits or coatings of the first material on the base body, formed by the second material, of the component can be made visible or can be identified. In this case, in particular for the processing or finishing of the component, for example by a technician, in particular when the component is a blade or a component of a fluid energy machine such as a gas turbine, the virtual component may be made visible in a variety of ways by configurations of the method according to the invention which are described below.

The method may, for example, also be summarized by the following steps: in a first step, in particular digital image recording of the component is carried out by the imaging method which allows clear discrimination between the base material and the coating. That is to say, the first material type or the first material can be distinguished from the second material type or the second material by the imaging method, to which end in particular hyperspectral imaging may for example be used as the imaging method.

Advantageously, this digital image recording or the capture may be applied from different directions, for example in order to be able to capture a component surface as a whole. In a further step, in particular by mathematical processing of the digital image recording, or of the electromagnetic radiations captured by the detection device, a false-color image with particularly high contrast between the base material and the coating, i.e. between the second material and the first material, is then initially produced. In this case, the selection of the contrast is advantageously made in such a way that the digital image can be converted by tonal separation into a binary mask for displaying the subregions, i.e. the residual layer locations. In a subsequent step, this false-color image, or the mask, which is configured in particular as a binary mask, is projected onto the CAD model of the in particular surveyed component, the projection being in particular an inverse projection. That is to say, the in particular two-dimensionally existing recording of the detection device, or the mask obtained therefrom and/or the false-color image, are projected onto the three-dimensional body of the CAD model. In this way, region assignments, that is to say respective first and respective second subregions, may be assigned to a 3D coordinate triplet of the CAD model by the mask, or the data which comprise the first and/or the second data.

Thus, for example for each image point that has been determined of the detection device, or of the first data and second data obtained therefrom, the former 2D pixel may now be placed in a 3D surface, representable for example by an electronic computation device, of the CAD model. In this case, the inverse projection, or the generation of the virtual three-dimensional model of the component which makes the corresponding subregions of the component with the respective materials visible, leads to a data fusion of geometrical configuration description and pictorially captured surface property, the false colors or region association showing whether or not a residual layer or a coating, and therefore the first material, is present at the corresponding point of the CAD model.

In this case, the model generated may substantially be regarded as a texturing for the CAD model. So that the three-dimensional model can be generated particularly advantageously, the capture of the electromagnetic radiation reflected by the at least one first subregion and of the second electromagnetic radiation reflected by the at least one second subregion, that is to say a recording, and the corresponding further conduct of the method are generally carried out several times, so that a plurality of images or recordings of the electromagnetic radiation can be made of the component, in order particularly to be able to capture the surface of the component completely, the recording being made from different views. The detection device is to this end, for example, swiveled around the component and respectively makes a capture in a plurality of different positions relative to the component. In this case, the captures or the recordings are generally carried out in such a way that there are respectively overlaps at least between two neighboring recordings, so that the surface of the component can be composited particularly advantageously. Thus, each recording provides a texture fragment for the model to be generated, the totality of these fragments, or of the data obtained therefrom, being capable of generating a complete texture layer for the part, in particular of interest, of the component or of the component surface and therefore of a workpiece surface.

The method according to the invention offers the advantage that a model, for example in the form of a CAD model, of the component can be provided, which may comprise information-carrying, complete textures that are obtained on the basis of the data obtained by the method, i.e. at least the first and second data. The virtual three-dimensional model obtained in this way is particularly advantageously suitable for providing information in a particularly advantageous way, for example to the technician who has to carry out further processing of the component, relating to positions of the first material located on the base body formed from the second material of the component. In this way, the method offers the advantage that a refurbishment process for components of a fluid energy machine, for example blades of the fluid energy machine which are exposed to particularly high temperatures, can be conditioned or restored in a particularly energy- and time-saving way. Furthermore, a further advantage of the method according to the invention may be that costs for processing of the component can be kept particularly low.

In one advantageous configuration of the invention, the virtual model is displayed at least partially by means of an electronic display device in such a type of way that the virtual first region of the model, corresponding to the first subregion, particularly in a first type of way, and the second region of the virtual model, corresponding to the second subregion, particularly in a second type of way different to the first type of way, are displayed in different types of way to one another, which are visually perceptible particularly with the human eye. In this case, processing of the component may be carried out, in particular by a technician and/or a machine, in particular as a function of the at least partially displayed virtual model. The at least partial display of the virtual model, or at least of the virtual first region or of the virtual second region, offers the advantage that processing, particularly in the form of finishing or reconditioning, of the component assigned in particular to a fluid energy machine can be made possible in a particularly simple and/or particularly rapid way for a person, in particular the technician.

In this case, for example, the first type of way may be a first texture of the model, configured in particular as a CAD model, and the second type of way is a second texture of the model, different to the first texture. The textures, or the types of way, may for example be represented on a display apparatus configured as a screen so that the technician can see, in particular conveniently and in particular while they are processing, for example blasting or grinding, the component, the correct places or regions, i.e. in particular the at least one first subregion of the component.

In one advantageous configuration, for example instead of or in addition to the different textures of the virtual model, the types of way that are visually perceptible may differ from one another in terms of respective colors of the regions. In this case, for example, the first color for the first type may represent a particular contrast in comparison with the second color for the second type, so that for example the coating, formed from the first material, of the base body, formed from the second material that is different to the first material, of the component can be displayed particularly advantageously for the technician.

In a further advantageous configuration of the invention, the virtual model is displayed on an electronic screen as a display device. By the use of a screen as the display device, the virtual model can be displayed particularly simply and therefore economically, so that processing of the component can be carried out particularly efficiently. The use of a screen furthermore offers the advantage that it can be seen by several persons, in particular technicians, so that for example coordination may be carried out in a particularly simple way over working steps possibly to be carried out.

In a further advantageous configuration of the invention, the display device is configured to be worn on a person's head, so that at least one of the regions of the virtual model is represented in a way which can be seen by at least one of the person's eyes by means of a display element of the display apparatus. In other words, the display apparatus is configured as a visual output instrument worn on the head, in which case the display device may for example comprise a holding element that holds the display element relative to the person's head on the latter. The holding element may in this case, for example, be a belt and/or a spectacle frame and/or an at least partially formed helmet shell.

The display element comprises for example a screen, which may in particular be configured to be transparent, semitransparent and/or opaque. In addition or as an alternative, the display element may be configured in such a way that, for example, it comprises a small projector that can project an image directly onto the retina of the eye. This involves a so-called light-field display or a virtual retinal display.

The display device may therefore be configured, for example, as a so-called head-mounted display or helmet-mounted display, in which case the head-mounted display may for example be smart glasses, in particular AR glasses and/or VR glasses.

The holding element may for example be a head mount, so that the display element follows in particular most, in particular all, head movements of a wearer. In addition, the display device may be provided with sensors in order to capture the head movements of the wearer. For the case in which the screen of the display element is opaque, the wearer may capture visual impressions which are separated, in particular fully, from an environment, so that for example the virtual model may be captured in a virtual space. This is done, for example, particularly advantageously by means of VR glasses, VR standing for a virtual reality into which the wearer of the display device is immersed. The technician or worker who wears such VR glasses does not, however, see the actual component because of the nontransparency of the display element. Accordingly, identification of the actual position of the technician's hands, for example by means of a sensor unit, with tools correspondingly held by them would be desirable so that, if the tool is for example a blasting lance or a grinding instrument, these may be used properly by the technician.

For AR glasses, for example with a light-field display or with a transparent or semitransparent display or a similar representation possibility, which comprises in particular a sensor unit for capturing the head movements of the wearer, the possibility arises that at least the first virtual region and/or the second virtual region, also the respective type, can be represented in such a way that it appears to the wearer of the AR glasses, or the technician, as if it were present directly on the component actually lying in the field of view of the wearer or technician. In this case, AR glasses are also referred to as augmented reality glasses, that is to say with the aid of the display apparatus there is a superposition of objects actually located in the field of view of the observer with additional information items adapted to the objects lying in the field of view of the observer. For example, the first type or the second type, and therefore information items relating to the first or second subregion, are overlaid directly onto the component, or the wearer of the display device receives the impression that, for example, a color change that marks the first material is actually taking place on the component. If the method is carried out in such a way that the data are available substantially in real time, the virtual regions may correspondingly be updated substantially in real time.

The display device configured to be worn on the head, and the possibility thereby provided of observing the in particular virtual image in actual reality by means of augmented reality or entirely in a virtual space by means of virtual reality, opens up the possibility, for example for the technician, of localizing the coatings or coating residues to be removed or finished, and therefore the first material, particularly advantageously on the base body, formed from the second material, of the component.

In a further advantageous configuration of the invention, at least one of the regions of the virtual model is projected, in particular optically, by at least one projector device directly onto the subregion, corresponding to the region, of the component. In other words, projection of an image that contains information relating to the subregions, i.e. for example the first type or the second type, onto the surface, in particular the workpiece surface, of the component is carried out by the at least one projection device. Thus, for the case in which the component constitutes a blade or a further component of a fluid energy machine, its surface is generally matt and particularly bright, so that the surface may be suitable as a projection screen for a projection. So that the region can be represented correctly on the corresponding subregion of the component, the curved component surface must be calculated in, in particular by mathematical rectification or distortion, so that the texture and/or the color can be represented correctly as the first type of the first region and/or the second type of the second region. Thus, in this embodiment of the method, the texture is transferred from the virtual three-dimensional model, i.e. the textured CAD model, by optical projection onto the real three-dimensional surface of the model, that is to say a textured component is virtually projected. This offers the advantage that the technician or the worker can change their perspective relative to the component in any desired way since the information relating to the materials is represented directly on the component surface, in particular by the types of representation, as if they were for example a wearer of body paint.

In a further advantageous configuration of the invention, the data are determined by machine vision, in particular by means of a computer vision routine. That is to say, the first and the second data are calculated or identified by means of machine vision, which may be referred to as image comprehension, with the aid of the first electromagnetic radiation and second electromagnetic radiation captured by the detection device. In this case, the machine vision is in particular computer-aided, that is to say objects, for example the first material or the second material, can be captured, for example in a recording of the detector device, by means of an electronic computation device. The determination of the data by means of machine vision offers the advantage in the method that the at least one first subregion and the at least one second subregion can be identified particularly advantageously, so that the three-dimensional virtual model can be formed particularly precisely.

In a further advantageous configuration of the invention, the component is a blade, in particular a rotor blade, guide vane and/or inlet blade, for a fluid energy machine, for example a gas turbine or an engine. In addition or as an alternative, in one advantageous configuration of the invention the second material comprises cobalt. The use of blades as a component offers the advantage in this method that particularly complexly configured components can undergo conditioning in a particularly straightforward way. For example, costs may be saved particularly well. Furthermore, the use of cobalt as in particular a constituent of an alloy that comprises at least the second material offers the possibility that electromagnetic radiation with a characteristic wavelength can be reflected.

In a further advantageous configuration of the invention, the first material comprises a ceramic and/or an adhesion promoter and/or MCrAlY, i.e. a chromium-aluminum-yttrium compound with metal. The effect of both the use of a ceramic and/or the adhesion promoter and/or the MCrAlY is that the first material may for example be configured to be particularly heat-sensitive, so that the component may be used particularly advantageously for example as a component of a fluid energy machine. This offers the advantage for the method that, if the detection device is selected in such a way that one of these materials can be identified particularly advantageously by the method, in particular on the basis of its reflection properties, and the virtual three-dimensional model may therefore be compiled, the method is particularly advantageously suitable for use as at least part of a refurbishment process in the reconditioning of blades for fluid energy machines, so that the refurbishment process can be carried out particularly advantageously.

In a further advantageous configuration of the invention, the electromagnetic radiations are captured by at least one hyperspectral recording. In other words, a hyperspectral camera device is used as the detection device. That is to say, the detection device is for example configured as a sensor system that can register recordings of very many wavelengths, in particular lying close to one another, of the electromagnetic spectrum. Thus, the detection device is configured for example to display respectively different wavelengths in a different wavelength range on a multiplicity of channels. For example, the hyperspectral recording may comprise information in a wavelength range that extends from the hard ultraviolet range to a longwave infrared wavelength range. The reflection property may thus be determined for a multiplicity of different wavelengths, so that both the first material and the second material may respectively be identified particularly advantageously for the compilation of the first data and/or the second data. This offers the advantage for the method that the determination of the respective subregions, or of the respective materials, may be carried out particularly precisely.

In a further advantageous configuration of the invention, at least one tool path for a tool for processing the component is compiled with the aid of the virtual model. Thus, the tool is for example a grinding or blasting tool which is configured to separate or remove the coating, or the first material, from the second material. In this embodiment, for example, the display of the model may be omitted and everything may for example be generated, or calculated, internally in an electronic computation device. The generation of the tool path may satisfy a prerequisite for fully automatic processing of the component, in particular fully automatic removal of the coating, with the aid of the textured, virtual three-dimensional model. It is therefore possible for the processing of the component to be carried out particularly efficiently by means of the method.

Further advantages, features and details of the invention may be found from the following description of an exemplary embodiment and with the aid of the drawings.

### BRIEF DESCRIPTION OF THE DRAWINGS

In this case, the single FIGURE shows a schematic flowchart of a method for capturing a coating, formed from a first material, of a component.

### DETAILED DESCRIPTION OF INVENTION

In the single FIGURE, there is a schematic flowchart of a method for capturing a coating 12, formed from a first material, of a component 10, in particular of a machine, for example of a fluid energy machine, which comprises at least one first subregion 14, in which a base body, formed from a second material different to the first material, of the component 10 is provided with the coating 12, and at least one second subregion 16, adjacent to the first subregion 14, in which the base body of the component 10 is free of the coating 12.

In order now to be able to perform the method particularly advantageously, so that the coating 12, for example in a refurbishment process or in reconditioning of a component 10 configured as blade for the fluid energy machine, may be removed particularly advantageously, the method comprises a plurality of steps:

In a first step S1, a first electromagnetic radiation 20 reflected by the first subregion 14 of the component 10 and a second electromagnetic radiation 20 reflected by the second subregion 16 of the component 10 are captured by means of a detection device 18. In this case, the first electromagnetic radiation 20 has for example at least one first wavelength. Furthermore, the second electromagnetic radiation 20 has at least one second wavelength different to the first wavelength. In a second step S2 of the method, first data 22, which characterize the first electromagnetic radiation 20 and the first subregion 14, and second data 24, which characterize the second electromagnetic radiation 20 and the second subregion 16, are generated. In this case, the data 22, 24 may in particular be determined advantageously by machine vision, in particular by a computer vision routine. In this case, for example, as an intermediate stage a false color, for example of the electromagnetic radiation 20 captured in particular in a hyperspectral recording, is processed, to which end the detection device 18 is advantageously configured as a hyperspectral recording device.

Thus, in the second step S2, for example, a false-color image is produced with maximum contrast between the second material, i.e. the base material of the component 10, and the first material, i.e. the coating 12 of the component 10. From this, for example, in particular by tonal separation, an in particular binary mask may be compiled which is projected later in a step S3 of the method for example onto a CAD (computer-aided design) model 26.

In the third step S3, a virtual three-dimensional model 28 of the component 10 is generated as a function of the data 22, 24, in such a way that the virtual model 28 comprises a virtual region 30 corresponding to the first subregion 14 and a virtual second subregion 32 corresponding to the second subregion 16.

In other words, the method is based on a combination of a digitized imaging method, for example the generation of a hyperspectral recording by the detection device 18, with an in particular mathematically based computer vision routine, which can be carried out by machine vision in step S2 of the method. In this case, the virtual three-dimensional model 28 of the component 10 may be represented by means of the method in a visual type of way, for example on a display apparatus. To this end, the virtual model 28 is advantageously displayed at least partially by means of the electronic display device, in such a way that the virtual first region 30, corresponding to the first subregion 14, of the model 28 is displayed in a first type of way, and the virtual second region 32, corresponding to the second subregion 16, of the virtual model is displayed in a second type of way different from the first type of way, and therefore in different types of way to one another, which are visually perceptible with the human eye.

Thus, in summary, a digital recording, in particular a hyperspectral recording, of the component 10 is generated by means of the detection device 18 in step S1 of the method by an imaging method, for example hyperspectral imaging, so as to allow clear discrimination between the base material, i.e. the second material, and the coating 12, i.e. the first material. Preferably, the method, or the compilation of the recording, is carried out from different viewing directions in order to capture a component surface of the component 10 as a whole. In step S2 of the method, the compilation of the data 22 and 24 is then carried out, so that the coating and the base body of the component 10 can be captured separately from one another in the model 28. This is done, for example, by means of the aforementioned mask.

In the third step S3 of the method, an inverse projection of the mask onto the CAD model 26 may then be carried out, in which case a projection may be carried out from the in particular two-dimensional hyperspectral recording, or the two-dimensional data 22, 24, onto the CAD model 26, in particular onto the three-dimensional surface thereof. In this way, for each image point of the data 22 and 24, a corresponding value thereof, i.e. the type of representation, for example in the form of a color or a texture, may be stored for the data of the CAD model 26, so that it is now possible to relocate from the previous 2D data 22 and 24 in the visible three-dimensional surface of the CAD model 26, so that the model 28 can be generated.

The inverse projection leads so to speak to a data fusion of geometrical configuration description, i.e. of the CAD model 26 and pictorially captured surface properties, which have been captured in step S1 by the detection device 18. Thus, for example, false-color representation leads to a region association which shows whether or not a point of the CAD model is coated with the coating, advantageously by means of texturing for the CAD model 26 in the model 28.

If, for example, a plurality of hyperspectral recordings of the component 10, or images of the component 10, or of the workpiece, are captured, each image or each hyperspectral recording provides a texture fragment for the surface of the component. Preferably, the fragments are recorded by the detection device 18 in such a way that they overlap for example at their edges so as to obtain a complete texture layer, in particular for the part of the workpiece, or of the workpiece surface, and therefore of the component 10, that is of interest to a technician for finishing of the component 10.

The display apparatus may, as mentioned, for example be an electronic screen. Advantageously, the display device and/or a further display device is in addition or as an alternative configured to be worn on a person's head so that at least one of the regions of the virtual model 28 can be represented in a way which is visible to at least one of the person's eyes by means of a display element of the display device. In this case, the display apparatus to be worn on the head may for example be smart glasses or a head-mounted display, which depending on the type of representation is suitable for presenting the technician with the full virtual model 28 in a virtual space, or for displaying the first region 30 and/or the second region 32 directly on the component 10 in a superimposed image with the actual component 10 by using augmented reality.

In addition or as an alternative, a projector device which optically projects precisely the regions 30, 32 of the virtual model 28 directly on the subregion 14 or 16, corresponding to the region, of the component 10 may be used for displaying the model 28 or at least partially displaying the model 28, i.e. for example displaying the region 30 or 32. This is advantageously possible in particular when the component 10 is a blade, in particular a rotor blade, guide vane and/or inlet blade, for a fluid energy machine, for example a gas turbine or an engine.

Preferably, the second material comprises cobalt, so that for example the second material may be captured particularly advantageously because of its reflection behavior in an alloy carried out as per steps S1 to S3.

Advantageously, the first material comprises a ceramic and/or an adhesion promoter and/or a metallic compound with chromium-aluminum-yttrium (MCrAlY). If the material comprises one of the aforementioned constituents, it may be used particularly advantageously as a coating for a component 10 configured as a blade as a fluid energy machine, so that the method is found to be particularly advantageous precisely for the refurbishing of turbines, or fluid energy machines, in particular for the heat resistance of the component 10 thereof, so that time and/or costs may particularly advantageously be saved.

By the proposed method, which may be used as an imaging measurement method for the chemical composition of the workpiece surface of the component 10, it is particularly advantageously possible to replace for example the so-called heat-tint, which colors the actual surface of the component 10 by strong heating with particularly high energy and time consumption. This also leads to the advantage that the surface of the component 10 is not modified by the proposed method, that is to say there is no color change, which may for example be desirable.

Thus, a technician may particularly advantageously finish the component 10 by the method. Furthermore, a tool path, for example for a grinding or blasting tool, could for example also advantageously be determined from the compiled model 28, so that in the future, for example, the finishing of the component 10, in particular the removal of the coating 12, may be carried out fully automatically. By the proposed method, the model 28, which may as a digital twin lead an interface to a multiplicity of types of digital use of the data 22, 24, is created.

### LIST OF REFERENCES

10 component
12 coating
14 first subregion
16 second subregion
18 detection device
20 electromagnetic radiation
22 first data
24 second data
26 CAD model
28 virtual model
30 first region
32 second region
S1 first step
S2 second step
S3 third step

1. A method for capturing a coating, formed from a first material, of a component which comprises at least one first subregion in which a base body, formed from a second material different to the first material, of the component is provided with the coating, and at least one second subregion, adjacent to the first subregion, in which the base body is free of the coating, the method comprising:
capturing a first electromagnetic radiation reflected by the first subregion of the component and a second electromagnetic radiation reflected by the second subregion of the component by a detection device;
generating first data, which characterize the first electromagnetic radiation and the first subregion, and second data, which characterize the second electromagnetic radiation and the second subregion;
generating a virtual three-dimensional model of the component as a function of the data, in such a way that the virtual model comprises a virtual first region corresponding to the first subregion and a virtual second region corresponding to the second subregion.

2. The method as claimed in claim 1, further comprising:
displaying the virtual model at least partially by an electronic display device in such a way that the virtual first region of the model, corresponding to the first subregion, and the virtual second region of the virtual model, corresponding to the second subregion, are displayed in different types of way to one another, which are visually perceptible with the human eye.

3. The method as claimed in claim 2,
wherein the virtual model is displayed on an electronic screen.

4. The method as claimed in claim 2,
wherein the display device is configured to be worn on a head of a person so that at least one of the regions of the virtual model is represented in a way which can be seen by at least one eye of the person by a display element of the display device.

5. The method as claimed in claim 1, further comprising:
projecting at least one of the regions of the virtual model by at least one projector device directly onto the subregion, corresponding to the region, of the component.

6. The method as claimed in claim 1,
wherein the data are determined by machine vision.

7. The method as claimed in claim 1,
wherein a blade for a fluid energy machine is used as the component and/or the second material comprises cobalt.

8. The method as claimed in claim 1,
wherein the first material comprises a ceramic and/or an adhesion promoter and/or MCrAlY.

9. The method as claimed in claim 1,
wherein the electromagnetic radiations are captured by at least one hyperspectral recording.

10. The method as claimed in claim 1,
wherein at least one tool path for a tool for processing the component is compiled with the aid of the virtual model.
